(19) United States
(12) Patent Application Publication
(10) Pub. No.: US 2025/0377957 A1
(43) Pub. Date: Dec. 11, 2025

(54) EVENT SOURCING FOR QUANTUM DEBUGGING AND FAILOVER MECHANISMS

(71) Applicant: Red Hat, Inc., Raleigh, NC (US)

(72) Inventors: Leigh Griffin, Waterford (IE); Andrea Cosentino, Milan (IT); Paolo Antinori, Milan (IT)

(21) Appl. No.: 18/738,906

(22) Filed: Jun. 10, 2024

(51) Int. Cl. G06F 9/54; G06N 10/70; G06N 10/20

(52) U.S. Cl. CPC G06F 9/542; G06N 10/70; G06N 10/20

(57) ABSTRACT

Event logging information is obtained from a plurality of event logging sources associated with execution of a quantum application, wherein the plurality of event logging sources comprises a quantum service and a classical service, and wherein the event logging information is descriptive of a plurality of service events and a corresponding plurality of timestamps. Occurrence of an error at a particular time is detected during execution of the quantum application. A subset of service events of the plurality of service events and a corresponding subset of timestamps of the plurality of timestamps are identified, wherein the subset of timestamps precede the particular time. A corrective action is performed for the error based at least in part on the subset of service events.

### BACKGROUND

Quantum computing is an emerging technology that exploits quantum mechanical phenomena. Quantum computing techniques organize information in qubits, which are analogous to the bits used in classical computing. Qubits can be implemented using a variety of different quantum computing devices (e.g., superconducting qubits, photonic qubits, etc.). One benefit to quantum computing devices is that they act as a source of true randomness. More specifically, measurements of quantum processes (e.g., implemented via the quantum computing devices) that are naturally non-deterministic can serve as truly random numbers for the provision of cryptographic services.

### SUMMARY

Implementations described herein provide event sourcing for quantum debugging and failover mechanisms. More specifically, a quantum computing system can obtain event logging information from event logging sources (e.g., quantum services, classical services, etc.). Based on detection of an error during execution of a quantum application, the quantum computing system can identify a subset of service event(s) from the event logging information. The quantum computing system can use the event logging information to perform a corrective action based at least in part on the subset of service events.

In one implementation, a method is provided. The method includes obtaining event logging information from a plurality of event logging sources associated with execution of a quantum application, wherein the plurality of event logging sources comprises a quantum service and a classical service, and wherein the event logging information is descriptive of a plurality of service events and a corresponding plurality of timestamps. The method further includes detecting, by the quantum computing system, occurrence of an error at a particular time during execution of the quantum application. The method further includes identifying, by the quantum computing system, a subset of service events from the plurality of service events and a corresponding subset of timestamps of the plurality of timestamps, wherein the subset of timestamps precede the particular time. The method further includes performing, by the quantum computing system, a corrective action for the error based at least in part on the subset of service events.

In another implementation, a quantum computing system is provided. The quantum computing system includes one or more computing devices. The one or more computing devices are to obtain event logging information from a plurality of event logging sources associated with execution of a quantum application, wherein the plurality of event logging sources comprises a quantum service and a classical service, and wherein the event logging information is descriptive of a plurality of service events and a corresponding plurality of timestamps. The one or more computing devices are further to detect occurrence of an error at a particular time during execution of the quantum application. The one or more computing devices are further to identify a subset of service events from the plurality of service events and a corresponding subset of timestamps of the plurality of timestamps, wherein the subset of timestamps precede the particular time. The one or more computing devices are further to perform a corrective action for the error based at least in part on the subset of service events.

In another implementation, a non-transitory computer-readable storage medium is provided. The non-transitory computer-readable storage medium includes executable instructions to cause one or more processor devices of a quantum computing system to obtain event logging information from a plurality of event logging sources associated with execution of a quantum application, wherein the plurality of event logging sources comprises a quantum service and a classical service, and wherein the event logging information is descriptive of a plurality of service events and a corresponding plurality of timestamps. The instructions further cause the one or more processor devices of a quantum computing system to detect occurrence of an error at a particular time during execution of the quantum application. The instructions further cause the one or more processor devices of a quantum computing system to simulate one or more service events of the plurality of service events to obtain simulation information, wherein the one or more service events are respectively associated with one or more timestamps of the plurality of timestamps that occurred prior to the particular time, and wherein the simulation information is indicative of a causative service event of the one or more service events that is causative of the error.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a quantum application execution environment with event error sourcing for quantum applications according to some implementations of the present disclosure.

FIG. 2 is a data flow diagram for simulating service events with the simulation system of the quantum computing system of FIG. 1 according to some implementations of the present disclosure.

FIG. 3 is a flowchart illustrating operations performed by the computing device of FIG. 1 for event error sourcing for quantum applications, according to one example.

FIG. 4 is a block diagram of the computing device of FIG. 1 for event error sourcing for quantum applications, according to one example.

FIG. 5 is a block diagram of the quantum computing system suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Quantum computing is an emerging technology that exploits quantum mechanical phenomena. Quantum computing techniques organize information in qubits, which are analogous to the bits used in classical computing. Qubits can be implemented using a variety of different quantum computing devices (e.g., superconducting qubits, photonic qubits, etc.). One benefit to quantum computing devices is that they act as a source of true randomness. More specifically, measurements of quantum processes (e.g., implemented via the quantum computing devices) that are naturally non-deterministic can serve as truly random numbers for the provision of cryptographic services.

In classical systems, “event sourcing” is a technique for architecting applications such that a current application state at any given time is not persistent. Rather, the current application state can be reconstructed from all events that happened up to that point. In other words, by sourcing the events that occurred prior to a current state of an application, event sourcing systems can recreate a current application state by recreating the events that led to the current application state. This manner of application architecture drives many conventional types of applications, such as serverless applications and middleware applications.

Applications created using an event-sourcing-based architecture provide a variety of benefits, such as application state reconstruction. However, applying the same techniques to quantum-based applications has proven to be prohibitively difficult. In particular, some quantum applications utilize truly random phenomena provided by qubits or other quantum computing devices. In addition, many quantum applications are not exclusively quantum, and instead utilize a mix of both classical and quantum computing services, devices, etc. Due to the unpredictability of quantum services, and the inherent difficulties in sourcing events from both classical and quantum-based services, event sourcing techniques have not yet been effectively applied to quantum applications.

Accordingly, implementations described herein provide for event sourcing for quantum debugging and failover mechanisms. More specifically, a quantum computing system can obtain event logging information from event logging sources (e.g., quantum services, classical services, computing device(s), network device(s), etc.). The event logging sources can be associated with execution of a quantum application.

For example, assume that a quantum application for cryptography is being executed. The quantum application may request a random number from a quantum service. The quantum service can generate the number and provide the number to the quantum application, and upon providing the number, can also provide a portion of event logging information to the quantum computing system. The generation and/or provision of the random number can constitute a service event, and can be described by event logging information provided by the quantum service. Further assume that the quantum service provides the random number to a classical computing service (e.g., a database service, a data repository service, etc.) to store the random number. Reception and/or storage of the random number by the classical computing service can constitute a service event, and can be described by event logging information provided by the classical computing service.

The quantum computing system can detect occurrence of an error during execution of the quantum application at a particular time. As described herein, an “error” that occurs during execution of the quantum application can refer to any event, operation, action, behavior, etc. that exhibits unexpected behavior. Examples of errors can include a cache miss, corrupted data, high latency during an exchange of information, bandwidth constraints, loss of power, etc. In some implementations, the quantum computing system can detect occurrence of an error based on information received from an event logging source. To follow the previous example, if the quantum computing service fails to generate the random number due to a hardware error (e.g., qubit failure, etc.), the quantum computing service can provide event logging information that indicates the occurrence of the error and the time at which the error occurred. In this manner, the time of error occurrence can be compared to timestamps associated with service events to identify service events that may be causative of the error.

Additionally, or alternatively, in some implementations, the quantum computing system can locally detect, or otherwise determine, the occurrence of an error. To follow the previous example, assume that the quantum computing service experiences a connectivity disruption prior to sending the random number to the quantum computing system. The quantum computing system can locally detect the occurrence of the error based on determining that a period of time has passed without receiving a random number responsive to the request.

Based on detection of an error during execution of the quantum application, the quantum computing system can identify a subset of service event(s) from the event logging information. In some implementations, the subset of service events can be identified based on a comparison between the time at which the error occurred and timestamps associated with the subset of service events. For example, if the error occurred 35.5 seconds after execution of the quantum application began, the quantum computing system may identify a subset of the service events that occurred between 30 seconds and 35.5 seconds.

Additionally, or alternatively, in some implementations, the quantum computing system can select the subset of service events based on the service event(s) and/or the error. For example, if the error is a connectivity error, the quantum computing system can select a subset of service events known (or determined) to be associated with connectivity errors (e.g., networking service events).

Responsive to identifying occurrence of the error, the quantum computing system can perform a corrective action for the error based at least in part on the subset of service events. To follow the previous example, if the detected error is a connectivity error, the quantum computing system can perform a corrective action by re-sending the random number request to the quantum service. For another example, the quantum computing system may perform a simulation or step-by-step “replay” of service events to identify service event(s) that are causative of the error. In such fashion, implementations described herein can be leveraged to enable error sourcing for quantum computing systems.

Aspects of the present disclosure provide a number of technical effects and benefits. As one example technical effect and benefit, implementations described herein can substantially reduce computational resource expenditure associated with error sourcing. More specifically, without a functional error sourcing architecture, the resource cost for manually sourcing an error can be prohibitively expensive. Additionally, quantum application execution environments are often distributed, with qubits often being located in different physical locations. This distributed execution environment exacerbates the difficulty in error sourcing without an error sourcing architecture. For example, while a temporary spike in latency between distributed qubits may cause an error, sourcing such an error would be prohibitively difficult. However, implementations described herein provide for efficient and accurate error sourcing in quantum computing environments, thus substantially reducing the computational resources necessary for error sourcing (e.g., compute cycles, power, memory, storage, etc.).

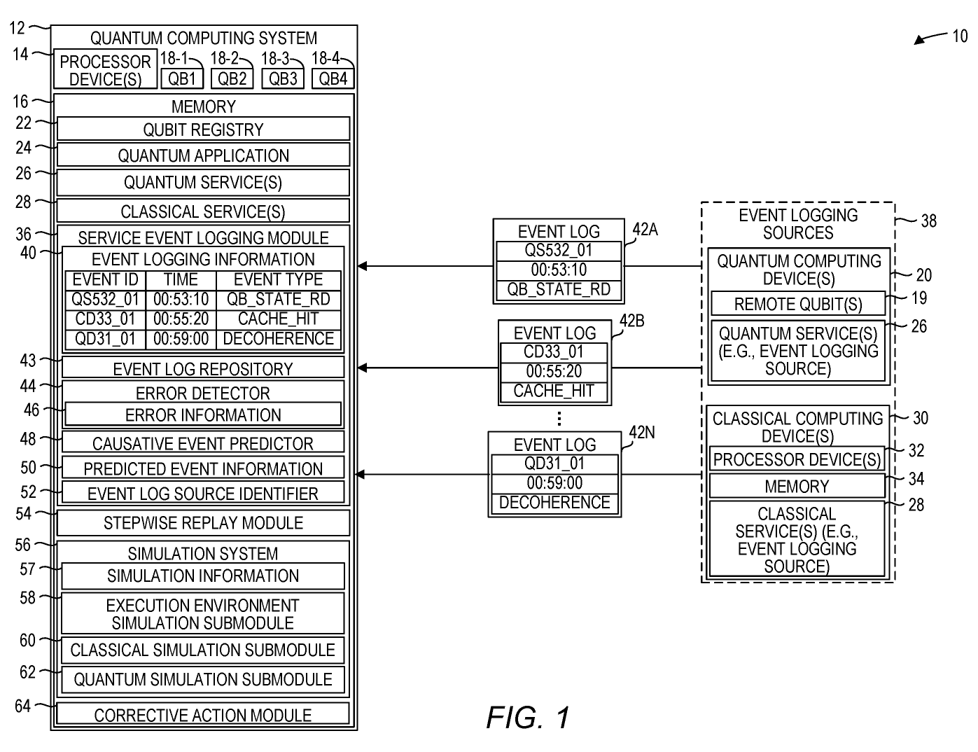

FIG. 1 is a block diagram of a quantum application execution environment 10 with event error sourcing for quantum applications according to some implementations of the present disclosure. The quantum application execution environment 10 includes a quantum computing system 12 that includes processor device(s) 14 and a memory 16. The quantum computing system 12 can operate in the quantum application execution environment 10 but can operate using classical computing principles and/or quantum computing principles. The quantum computing system 12 can be any type or manner of computing device or network node, and can include physical computing device(s) (e.g., Central Processing Units (CPUs), Graphics Processing Units (GPUs), memory, accelerators, virtualized device(s) or service(s), etc. For example, the quantum computing system 12 can be a virtualized node within a cloud-based computing environment that has indirect access to computing resources through a virtualization layer.

The processor device(s) 14 of the quantum computing system 12 may include any computing or electronic device capable of executing software instructions to implement the functionality described herein. The memory 16 of the quantum computing system 12 can be or otherwise include any device(s) capable of storing data, including, but not limited to, volatile memory (random access memory, etc.), non-volatile memory, storage device(s) (e.g., hard drive(s), solid state drive(s), etc.). In particular, the memory 16 can include a containerized unit of software instructions (i.e., a “packaged container”). The containerized unit of software instructions can collectively form a container that has been packaged using any type or manner of containerization technique.

The containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

The quantum computing system 12 can implement, include, or otherwise access qubits 18-1 – 18-4 (generally, qubits 18). It should be noted that, in some implementations, one or more of the qubits 18 may be located on a quantum computing device or system located remotely from the quantum computing system 12. For example, qubits 18-1 – 18-2 may be components of, and located at, the quantum computing system 12. Qubits 18-3 – 18-4 may be located at quantum computing device(s) 20. For example, the quantum computing device(s) 20 can include remote qubit(s) 19 (e.g., a pair of qubits located at the same location, a distributed set of networked qubits located at different locations). The quantum computing device(s) 20 may allocate remote qubit(s) 19 to serve as one (or more) of the qubits 18. The remote qubits 19 can process information remotely at the quantum computing device(s) 20, which may in turn communicate processed information to the quantum computing system 12 (e.g., via one or more networks, etc.). In such fashion, the quantum computing system 12 may increase a quantum processing capacity by leveraging remotely located qubits.

The quantum application execution environment 10 is a logical grouping, or clustering, of computing systems, devices, and/or resources. More specifically, the quantum application execution environment 10 is an environment in which a number of separate devices and/or systems share resources (e.g., hardware resources, compute cycles, services, etc.) via a central management framework that enforces consistent configuration and policies. It should be noted that the quantum application execution environment 10 can include any type or manner of computing device or system. For example, in some implementations, the quantum application execution environment 10 can include a number of quantum computing systems and classical computing systems. Additionally, in some implementations, the quantum application execution environment 10 can include quantum computing devices, such as quantum computing device(s) 20, that can implement and measure quantum processes. For example, the quantum computing device(s) 20 can include hardware and/or software resources that implement quantum processes by maintaining photon(s) in superposition.

The memory 16 of the quantum computing system 12 includes a qubit registry 22 that maintains information about the qubits 18-1 – 18-4, including, by way of non-limiting example, a total qubits counter that identifies the total number of qubits 18 implemented by the quantum computing system 12, a total available qubits counter that maintains count of the total number of qubits 18 that are currently available for allocation, etc. In some implementations, the remote qubits can be located at different locations. For example, the quantum service(s) 26 can include a first quantum service implemented with a first set of the remote qubit(s) 19 located at a first geographic location, and a second quantum service implemented using a second set of the remote qubit(s) 19 located at a second geographic location different than the first geographic location.

The memory 16 can include a quantum application 24. The quantum application 24 can be executed within the quantum application execution environment 10. Specifically, the quantum application 24 can be executed using at least some of the qubits 18 and/or the remote qubits 19. For example, if the quantum application 24 is a random number generator application, the quantum application 24 may utilize a current observed state of one or more of the qubits 18 as a seed for random number generation.

In some implementations, classical computing components and/or services within the quantum application execution environment 10 can be utilized to execute the quantum application 24. To follow the previous example, assume that the qubits utilized by the quantum application 24 as a seed for random number generation are the remote qubits 19 located at the quantum computing device(s) 20. The quantum application 24 may request the random values of the observed qubits via a classical device or infrastructure, such as a network adapter, wireless network infrastructure, etc. As described herein, a “classical” device, service, software, etc. can refer to any entity that does not utilize quantum processes.

In some implementations, the memory 16 of the quantum computing system 12 can include, or otherwise implement, a quantum service(s) 26. As described herein, a quantum service refers to a service that receives a request, and in response, generates an output based at least in part on quantum information. For example, the quantum service(s) 26 may directly interact with the qubits 18 and/or the remote qubit(s) 19 (e.g., observing the qubits, measuring a value of the qubits, etc.), and generate an output based on the interaction. For another example, the quantum service(s) 26 may request that quantum information be retrieved from the qubits 18 and/or the remote qubit(s) 19 by another entity (e.g., another quantum service or device, etc.), and then generate an output based on the retrieved quantum information.

The quantum service(s) 26 can be a service that at least partially utilizes quantum information (e.g., obtained from qubits, such as the qubits 18 and/or the remote qubits 19, etc.) to generate an output. The quantum service(s) 26 can include any type or manner of service, such as the qubit registry 22. For example, assume that the quantum service(s) 26, rather than the quantum application 24, provides random numbers based on observations of qubits. If the quantum application 24 utilizes truly random numbers during execution of the quantum application 24, the quantum application 24 can request the random numbers from the quantum service(s) 26. The quantum service(s) 26 can then return the random numbers to the quantum application 24.

Additionally, or alternatively, in some implementations, the quantum service(s) can be implemented via the quantum computing device(s) 20. To follow the previous example, rather than requesting the random numbers from the quantum service(s) 26 via internal communication mechanisms of the quantum computing system 12 (e.g., inter-process communication APIs, system busses, etc.), the quantum application 24 can request the random numbers from the quantum service(s) 26 implemented remotely at the quantum computing device(s) 20. In some implementations, one quantum service of the quantum service(s) 26 can be implemented at the quantum computing system 12, while another of the quantum service(s) 26 can be implemented at the quantum computing device(s) 20.

In some implementations, the memory 16 of the quantum computing system 12 can include, or otherwise implement, classical service(s) 28. The classical service(s) 28 can refer to any type or manner of service that generates an output that is not based on quantum information. In other words, the classical service(s) 28 can perform operations without any direct or indirect interaction with a qubit. However, it should be noted that, in some implementations, a classical service may still indirectly utilize information from qubits to generate an output or perform a task. For example, if the classical service(s) 28 include a data repository, the quantum computing system 12 may store quantum measurements (e.g., observed phenomena such as spin direction, polarity, etc.), and/or non-quantum measurements (e.g., temperature, qubit latency, location, etc.).

In some implementations, the quantum service(s) 26 can be implemented using classical computing devices (i.e., devices that do not operate on quantum principles), such as Central Processing Units (CPUs), Graphics Processing Units (GPUs), etc. Additionally, or alternatively, in some implementations, the quantum service(s) 26 can be implemented at classical computing device(s) 30 of the quantum application execution environment 10. More specifically, the quantum application execution environment 10 can include one or more classical computing devices 30. The one or more classical computing devices 30 can include processor device(s) 32 and memory 34, as described with regards to the processor device(s) 14 and the memory 16 of the quantum computing system 12, respectively. The classical computing device(s) 30 can implement the classical service(s) 28.

The quantum service(s) 26 and the classical service(s) 28 within the quantum application execution environment 10 can be associated with execution of the quantum application 24. As described herein, a service can be “associated” with execution of the quantum application 24 if the service is interacted with during execution of the quantum application 24. For example, if the quantum application 24 stores data to a classical data storage service during execution of the quantum application 24, the classical data storage service can be associated with execution of the quantum application 24.

Additionally, in some implementations, a service can be “associated” with execution of the quantum application 24 if the service is interacted with prior to, or subsequent to, execution of the quantum application 24. For example, assume that the classical service 28 is virtual machine orchestration service that instantiates a virtual machine for use by the quantum application 24 prior to execution of the quantum application 24. Even if the classical service 28 is not utilized once execution of the quantum application 24 begins, the classical service 28 may still be considered associated with execution of the quantum application 24 due to the operations of the classical service 28 facilitating subsequent execution of the quantum application 24.

Additionally, in some implementations, a service can be “associated” with execution of the quantum application 24 if the service interacts with another associated service during execution of the quantum application 24. For example, assume that the quantum application 24 requests a random number from a random number generation service of the quantum service(s) 26. Further assume that the random number generation service stores randomly generated numbers to a classical data storage service for security purposes. The data storage service can be considered “associated” with the execution of the quantum application even if the data storage service does not interact directly with the quantum application 24.

The memory 16 of the quantum computing system 12 can include a service event logging module 36. The service event logging module 36 can log events that occur during execution of the quantum application 24 within the quantum application execution environment 10. As described herein, a “service event” can refer to any input, output, information or exchange thereof, operation, process, etc. of a service, such as the quantum service(s) 26 and the classical service(s) 28. Specifically, a classical service event can refer to a service event from a classical computing device or service, while a quantum service event can refer to a service event from a quantum computing device or service. In some implementations, the service events may also refer to an event that occurs at a device utilized to implement a service. For example, a cache miss by the processor device(s) 32 while implementing the classical service(s) 28 can constitute a service event.

The service event logging module 36 can log information describing service events from event logging sources 38. As described herein, an “event logging source” can refer to any service and/or device at which a service event can occur. Examples of the event logging sources 38 can include the quantum service(s) 26, the classical service(s) 28, the quantum computing device(s) 20, the qubits 18, the remote qubit(s) 19, the classical computing device(s) 30, the processor device(s) 32, and any other device(s) or service(s) utilized within the quantum application execution environment 10 (e.g., network devices or services, etc.).

The service event logging module 36 can obtain, store, and otherwise manage event logging information 40. The event logging information 40 can include information describing service events and corresponding timestamps at which the service events occurred. The event logging information 40 can be obtained from the event logging sources 38. More specifically, the event logging information 40 can be based on event logs 42A – 42-N (generally, event logs 42). The event logs 42 can describe one or more service events detected by the sender of the event logs 42.

For example, assume that a service event, such as a qubit read event (i.e., measuring the current state of a qubit), occurs at one of the remote qubits 19. Responsive to occurrence of the service event, the quantum computing device(s) 20 that include the remote qubits 19 can provide the event log 42A to the quantum computing system 12 that describes the service event. The service event logging module 36 can generate some of the event logging information 40 based on the event log 42A. For example, the service event logging module 36 may include the event log 42A as an entry in the event logging information 40. For another example, the service event logging module 36 can extract information from the event log 42A for inclusion in the event logging information 40.

In some implementations, the event logs 42 can be received asynchronously. For example, the quantum computing system 12 can receive the event log 42A (i.e., a first portion of the event logging information) from the quantum computing device(s) 20 at a first time. The quantum computing system 12 can then receive the event log 42B (i.e., a second portion of the event logging information) from another of the quantum computing device(s) 20 at a second time subsequent to the first time. The quantum computing system 12 can generate the event logging information based on the event logs 42A and 42B (i.e., first portion of the event logging information and the second portion of the event logging information).

In some implementations, the service event logging module 36 can modify the event log 42A prior to storage within the event logging information 40. For example, if the event log 42A includes a transmission timestamp (e.g., a time at which the event log 42A was transmitted by the quantum computing device(s) 20), the service event logging module 36 can determine a reception timestamp (e.g., a time at which the event log 42A was received from the quantum computing device(s) 20), and modify the event log 42A to include the reception timestamp prior to inclusion of the event log 42A within the service event logging module 36.

In some implementations, the service event logging module 36 can generate at least some of the event logs 42, rather than receiving the event logs 42 from a sending entity. For example, assume that the quantum application 24 interacts with the classical service(s) 28 during execution of the quantum application 24. The service event logging module 36 can detect the interaction and generate a corresponding event log describing the service event (e.g., the interaction between the quantum application 24 and the classical service 28).

The service event logging module 36 can include an event log repository 43. The event log repository 43 can store event logging information generated previously by the service event logging module 36. For example, the service event logging module 36 can store a discrete portion of the event logging information 40 to the event log repository 43 at regular intervals, and/or when the occurrence of certain events is detected (e.g., cessation of execution of the quantum application 24, an error event, etc.).

The service event logging module 36 can include an error detector 44. The error detector 44 can detect occurrence of an error at a particular time during execution of the quantum application 24. More specifically, the error detector 44 can generate error information 46 that describes the error detected by the error detector 44. In some implementations, the error detector 44 can detect errors based on the event logging information 40 and/or the event logs 42. For example, the error detector 44 can analyze the event logging information 40. Based on a portion of the event logging information 40 extracted from the event log 42, the error detector 44 can detect occurrence of a quantum decoherence error. Additionally, or alternatively, in some implementations, the error detector 44 can detect an error based on error reporting received from one of the quantum computing device(s) 20, the quantum service(s) 26, the classical service(s) 28, etc.

The service event logging module 36 can include a causative event predictor 48. The causative event predictor 48 can predict whether one (or more) of the service events described in the event logging information 40 are causative of the error described by the error information 46. More specifically, the causative event predictor 48 can generate predicted event information 50. The predicted event information 50 can indicate a subset of service events from the plurality of service events described by the event logging information 40 that may be causative of the error.

The predicted event information 50 can describe the subset of service events and a corresponding subset of timestamps. In particular, the timestamps for the subset of events can each occur prior to occurrence of the error. In this manner, the error detector 44 can isolate service events that are more likely to be causative of the error. For example, the causative event predictor 48 can determine a subset of timestamps from the plurality of timestamps corresponding to the plurality of service events described by the event logging information 40. The subset of timestamps can be a sequence of timestamps immediately preceding the particular time at which the error occurred.

In some implementations, the causative event predictor 48 can utilize a heuristic selection process to predict the service events that may be causative of the error. For example, the causative event predictor 48 may select all service events that occurred during the last five minutes preceding occurrence of the error. Additionally, or alternatively, in some implementations, the causative event predictor 48 can filter service events from the subset of service events described by the predicted event information 50. For example, the causative event predictor 48 may filter service events from the subset of service events if they occurred at entity(s) (e.g., devices, services, etc.) that do not interact with the entity at which the error occurred.

In some implementations, the causative event predictor 48 can perform an analysis of service events described by the event logging information 40 based on the error information 46 to generate the predicted event information describing the subset of service events. For example, assume that the predicted event information 50 describes a quantum decoherence error that occurred at one of the remote qubits 19. The causative event predictor 48 can determine which device(s) and/or service(s) interacted with the remote qubits 19 during a period of time preceding occurrence of the error. The causative event predictor 48 can then select the service events that occurred at those device(s) and/or service(s) for inclusion in the predicted event information 50. Alternatively, the causative event predictor 48 can instead filter the service events that occurred at other device(s) and/or service(s) from the predicted event information 50.

The memory 16 of the quantum computing system 12 can include an event logging source identifier 52. The event logging source identifier 52 can identify one or more of the event logging sources 38 predicted to be causative of the error described by the error information 46. For example, assume that the error described by the error information 46 is a “NO RESPONSE” error from the quantum service(s) 26. Further assume that the quantum service(s) 26 are implemented at least partially with the remote qubits 19, and that the “NO RESPONSE” error was caused by the remote qubits 19 being unavailable for utilization by the quantum service(s) 26. The event log source identifier 52 can predict that the quantum computing device(s) 20, and/or the remote qubits 19, are causative of the error. Alternatively, if the remote qubits 19 are unavailable due to failure of some other entity, such as a network device, the event log source identifier 52 can determine that the network device is likely causative of the error while the remote qubits 19 and the quantum computing device(s) are not. In such fashion, the event log source identifier 52 can analyze the event logging information 40 to identify a subset of the event logging sources 38 associated with, or likely to be causative of, the error.

In some implementations, the event log source identifier 52 can be utilized by the causative event predictor 48. More specifically, the causative event predictor 48 can utilize the event log source identifier 52 to identify which of the event logging sources 38 from be featured in predicted event information 50. For example, the event log source identifier 52 can process the event logging information 40 to determine that the classical computing device(s) 30 are unlikely to be causative of the error described by the error information 46. In response, the event log source identifier 52 can exclude the event logs 42 associated with service events that occur at the classical computing device(s) 30 from the predicted event information 50.

In some implementations, the memory 16 of the quantum computing system 12 can include a stepwise replay module 54. The stepwise replay module 54 can perform a stepwise replay of the events that occurred prior to occurrence of the error. The stepwise replay module 54 can then analyze the behavior that occurs during replay of the events. For example, the stepwise replay module 54 can compare behavior observed while the events are replayed with the behavior that occurred while the events originally occurred. For another example, the stepwise replay module 54 can compare behavior observed while the events are replayed with known or expected “ground-truth” behavior.

More specifically, in some implementations, the stepwise replay module 54 can replay, or perform, the service events described by the predicted event information 50. For example, assume that the service events described by the predicted event information 50 include a service event in which the quantum computing system 12 requests information from the quantum computing device(s) 20. The stepwise replay module 54 can replay the events that led to the quantum computing system 12 requesting the information, and can then request the same information from the quantum computing device(s) 20. By replaying the preceding events in the same manner as they occurred originally, the quantum computing device(s) 20 can be placed in the same state as when the service events first occurred. In such fashion, the stepwise replay module 54 can accurately and effectively facilitate error sourcing based on the event logging information 40.

In some instances, service events cannot be accurately “replayed” by the stepwise replay module 54 due to the uncertainty inherent to quantum phenomena. In other words, replaying events that involve quantum phenomena using a classical approach can be prohibitively difficult, and is usually inaccurate to a degree that defeats attempts at accurate error sourcing. Accordingly, in some implementations, the memory 16 of the quantum computing system 12 can include a simulation system 56.

The simulation system 56 can simulate the quantum application execution environment 10 during execution of the quantum application 24. More specifically, the simulation system 56 can simulate specific states of the quantum application execution environment at specific times based on the event logging information 40. To do so, the simulation system 56 can utilize the qubits 18, and/or the remote qubits 19, to simulate the operations performed with the qubits originally.

In some implementations, the simulation system 56 can simulate one or more service events of the plurality of service events to obtain simulation information. The one or more service events can be respectively associated with one or more timestamps of the plurality of timestamps that occurred prior to the particular time. The simulation information can be indicative of a causative service event of the one or more service events that is causative of the error.

In some implementations, the simulation system 56 can simulate interactions between qubits (or devices / services that utilize qubits or quantum phenomena). Additionally, in some implementations, the simulation system 56 can be utilized by the stepwise replay module 54 to do so. For example, assume that the error described by the error information 46 is a quantum decoherence error. The simulation system 56 can simulate the quantum application execution environment 10 at the time of the quantum decoherence error to predict a cause of the error.

In some implementations, the simulation system 56 can include an execution environment simulation submodule 58. The execution environment simulation submodule 58 can simulate the quantum application execution environment 10 such that the state of the simulated quantum application execution environment is similar (or identical to) the state of the quantum application execution environment 10 at the time when the error occurred. In this manner, by accurately simulating all entities within the environment, the simulation system 56 can ensure that interactions between such entities, which may or may not be causative of the error, are accurately simulated.

The simulation system 56 can generate simulation information 57 describing a simulation performed by the simulation system 56. The simulation information 57 can be descriptive of the quantum application execution environment 10 in which the quantum application 24 was executed during a period of time. In some implementations, as illustrated, the simulation system 56 can be implemented by the quantum computing system 12, or can otherwise be a component of the quantum computing system 12. Alternatively, in some implementations, the simulation system 56 can be separate from the quantum computing system 12, and the quantum computing system 12 can cause simulation by providing the event logging information 40 (and/or the error information 46) to the simulation system 56 alongside a request to perform the simulation.

In some implementations, the simulation system 56 can perform simulations in accordance with simulation parameters, or sets of simulation parameters (not illustrated). More specifically, in some implementations, an execution environment can be described by a set of simulation parameters, and the simulation system 56 can use the set of simulation parameters to simulate the execution environment.

In some implementations, the simulation system 56 can obtain a first set of simulation parameters (not illustrated) that describe the quantum application execution environment 10 at the time (or period of time) at which the application was executed. For example, the simulation system 56 can obtain a first set of simulation parameters that describe a number of available qubits, type(s) of qubits, a degree of noise, a degree of heat, operation flow for asynchronous events, a degree of latency, available hardware devices, firmware or software installed to such hardware devices, available computing services, etc. The simulation system 56 can perform a simulation based on the first set of simulation parameters to obtain a first portion of the simulation information 57. The first portion of the simulation information 57 can describe the execution environment in which the quantum application was executed during the period of time preceding the particular time.

In some implementations, the simulation system 56 can obtain a second set of simulation parameters (not illustrated) that describe an execution environment different than the environment described by the first set of simulation parameters. For example, the simulation system 56 can obtain a second set of simulation parameters with different values for the number of available qubits, type(s) of qubits, degree of noise, etc. The simulation system 56 can perform a second simulation based on the second set of simulation parameters to obtain a second portion of the simulation information 57. In such fashion, the simulation system can facilitate discovery of solutions (e.g. when the error does not occur when using certain sets of parameters), and may expose other errors that were not encountered when strictly emulating the execution environment.

In some implementations, the simulation system 56 can include a classical simulation submodule 60. The classical simulation submodule 60 can include (or access) classical computing devices such as the classical computing device(s) 30 to simulate service events that occurred at classical computing device(s).

Similarly, the simulation system 56 can include a quantum simulation submodule 62. The quantum simulation submodule 62 can include (or access) quantum computing devices such as the quantum computing device(s) 20 or the remote qubit(s) 19 to simulate service events that occurred at quantum computing device(s). For example, the quantum simulation submodule 62 can include a quantum computing device with one or more qubits (not illustrated). The quantum computing system 12 can provide the event logging information 40 to the simulation system 56. Based on the event logging information 40, the quantum simulation submodule 62 can simulate a service event from one of the quantum service(s) 26 using the quantum computing device. The quantum computing system 12 can then receive simulation information describing the results or output of the simulation system.

The memory 16 of the quantum computing system 12 can include a corrective action module 64. The corrective action module 64 can perform corrective actions to correct for the error described by the error information 46. In some implementations, the corrective actions performed by the corrective action module 64 can include reporting information, such as the error information 46, the predicted event information 50, information produced by the event log source identifier 52, etc. For example, if the error is a quantum decoherence error at one of the remote qubits 19, the corrective action module 64 can report the quantum decoherence error to the quantum computing device that implements the qubit in question.

Additionally, or alternatively, in some implementations, the corrective actions performed by the corrective action module 64 can modify or interact with the quantum application 24, or otherwise modify execution of the quantum application 24. To follow the previous example, after reporting the quantum decoherence error to the quantum computing device, the corrective action module 64 can instruct the quantum application to pause utilization of quantum device(s) or service(s) for a period of time sufficient to enable remote correction of the error at the remote qubit 19. In this manner, the corrective action module 64 can mitigate occurrence of additional errors caused by the same error source. Alternatively, the corrective action module 64 may instead instruct the quantum application to utilize qubits, or service(s) driven by qubits, other than the qubits affected by the error (e.g., the qubits 18 rather than the remote qubit(s) 19.

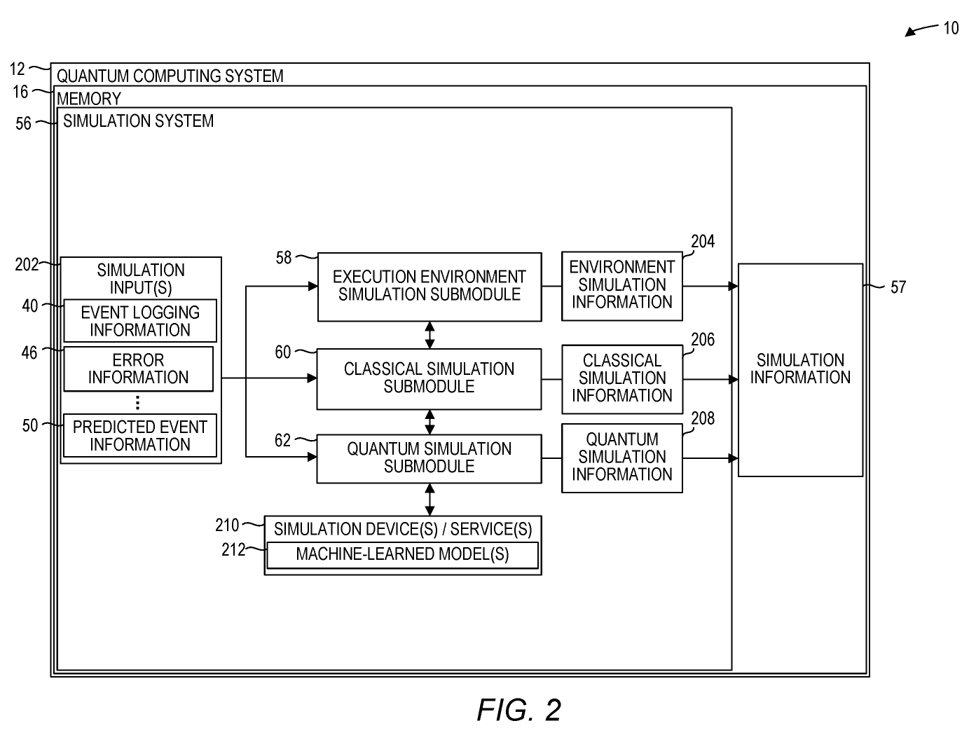

FIG. 2 is a data flow diagram for simulating service events with the simulation system 56 of the quantum computing system 12 of FIG. 1 according to some implementations of the present disclosure. FIG. 2 will be discussed in conjunction with FIG. 1. More specifically, the quantum computing system 12 can include the simulation system 56. The simulation system 56 can obtain simulation inputs 202. The simulation inputs 202 can include information obtained and/or by the quantum computing system 12, such as the event logging information 40, the error information 46, the predicted event information 50, event log sourcing information produced by the event log source identifier 52 (not illustrated), etc.

The simulation system 56 can provide the simulation inputs 202 to the execution environment simulation submodule 58, the classical simulation submodule 60, and the quantum simulation submodule 62. Each of the submodules 58 – 62 can process the simulation inputs 202 to collectively generate the simulation information 57.

In some implementations, the submodules 58 – 62 can exchange simulation information to generate the simulation information 57. For example, the execution environment simulation submodule 58 can generate environment simulation information 204 and provide the environment simulation information 204 to the classical simulation submodule 60. The classical simulation submodule 60 can then utilize the environment simulation information 204 as an input, or conditioning signal, to generate classical simulation information 206. Similarly, the classical simulation submodule 60 can generate the classical simulation information 206 and provide the classical simulation information 206 to the quantum simulation submodule 62. The quantum simulation submodule 62 can then utilize the environment simulation information 204 and/or the classical simulation information 206 as input(s), or conditioning signal(s), to generate quantum simulation information 208.

In some implementations, the submodules 58 – 62 can utilize simulation device(s) / service(s) 210 to generate the simulation information 57. The simulation device(s) / service(s) 210 can include device(s) (e.g., quantum computing devices, qubits, classical devices, etc.), service(s), virtualized device(s), etc. for simulating corresponding device(s) / service(s) associated with the quantum application 24. In some implementations, the simulation device(s) / service(s) 210 can include machine-learned simulation model(s) 212. The machine-learned simulation model(s) 212 can include any type or manner of model(s). For example, the machine-learned simulation model(s) 212 can include a machine-learned error sourcing model. The machine-learned error sourcing model can generate an output that identifies a subset of service events from the plurality of service events. The machine-learned error sourcing model can be trained to predict which service events are causative of an error.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

In some implementations, the machine-learned simulation model(s) 212 can be leveraged by the submodules 58 – 62 to generate the simulation information 57. In some implementations, the machine-learned simulation model(s) 212 can include model(s) trained to emulate steps, operations, processes, etc. implemented by event logging sources. For example, assume that the predicted event information 50 predicts that a particular service event is likely causative of the error described by the error information 46. Further assume that the event logging information 40 does not include an event log for the particular service event because the event log was not received due to network failure. The machine-learned simulation model(s) 212 can process the event logging information 40 to generate a synthetic event log for the particular event. Additionally, or alternatively, in some implementations, the machine-learned simulation model(s) 212 can include model(s) trained to analyze the simulation information 57.

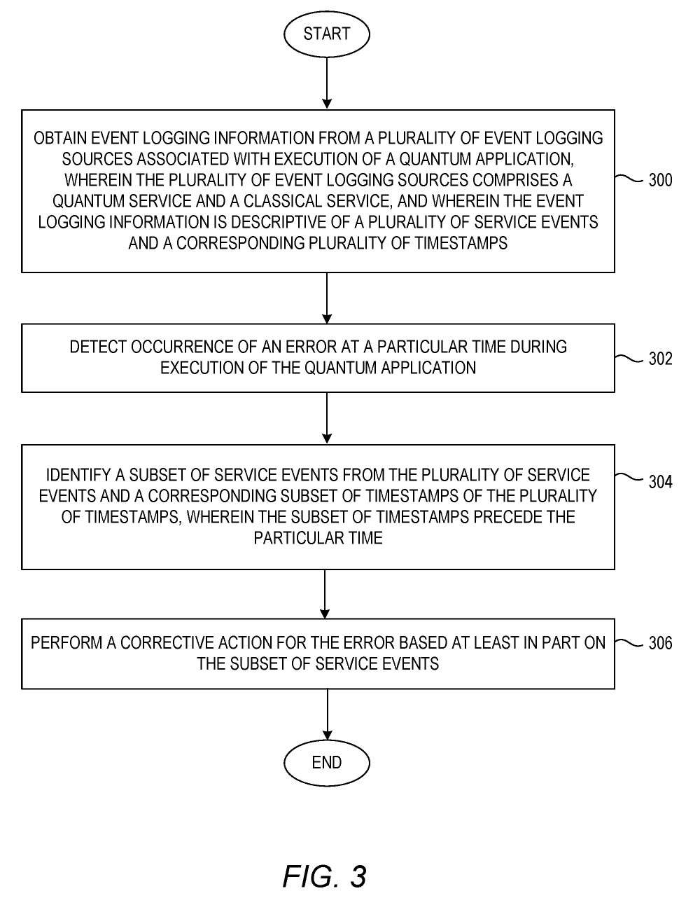

FIG. 3 is a flowchart illustrating operations performed by the computing device of FIG. 1 for event error sourcing for quantum applications, according to one example. Elements of FIG. 1 are referenced in describing FIG. 3 for the sake of clarity. In FIG. 3, operations begin with a processor device of a computing device, computing system, network node, etc., such as the processor device(s) 14 of the quantum computing system 12 of FIG. 1. The processor device(s) 14 are to obtain event logging information 40 from a plurality of event logging sources 38 associated with execution of a quantum application 24, wherein the plurality of event logging sources 38 comprises a quantum service 26 and a classical service 28, and wherein the event logging information is descriptive of a plurality of service events and a corresponding plurality of timestamps (block 300). The processor device(s) 14 are further to detect occurrence of an error (e.g., error information 46) at a particular time during execution of the quantum application 24 (block 302). The processor device(s) 14 are further to identify a subset of service events (e.g., the predicted event information 50) from the plurality of service events and a corresponding subset of timestamps of the plurality of timestamps, wherein the subset of timestamps precede the particular time (block 304). The processor device(s) 14 are further to perform a corrective action for the error based at least in part on the subset of service events (block 306).

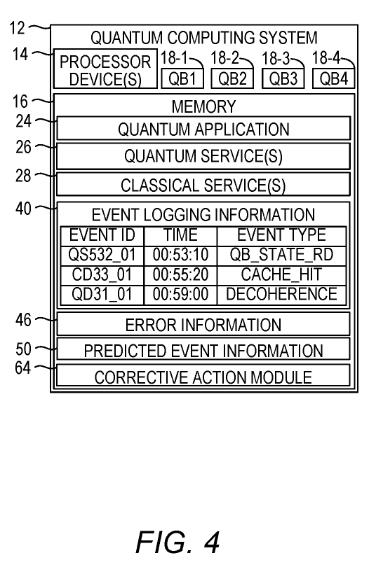

FIG. 4 is a block diagram of the computing device of FIG. 1 for event error sourcing for quantum applications, according to one example. Elements of FIG. 1 are referenced in describing FIG. 4 for the sake of clarity. In the example of FIG. 4, the quantum computing system 12 includes a memory 16 and processor device(s) 14 coupled to the memory 16. The processor device(s) 14 are to obtain event logging information 40 from a plurality of event logging sources 38 associated with execution of a quantum application 24. The plurality of event logging sources 38 can include a quantum service 26 and a classical service 28. The event logging information 40 is descriptive of a plurality of service events (e.g., corresponding to event logs 42) and a corresponding plurality of timestamps (e.g., described by the event logs 42). The processor device(s) 14 are further to detect occurrence of an error a particular time (e.g., described by the error information 46) during execution of the quantum application 24. The processor device(s) 14 are further to identify a subset of service events (e.g., the predicted event information 50) from the plurality of service events (e.g., described by the event logging information 40) and a corresponding subset of timestamps of the plurality of timestamps. The processor device(s) 14 are further to perform a corrective action (e.g., via the corrective action module 64) for the error based at least in part on the subset of service events (e.g., described by the predicted event information 50).

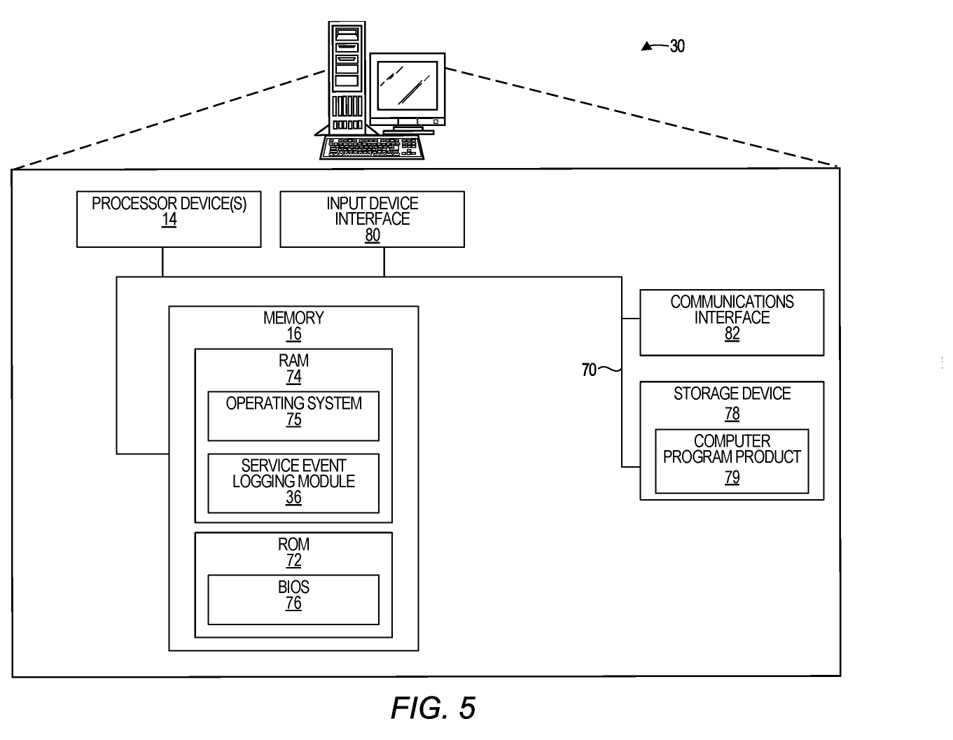

FIG. 5 is a block diagram of the quantum computing system 12 suitable for implementing examples according to one example. The quantum computing system 12 may comprise any computing or electronic device capable of including firmware, hardware, and/or executing software instructions to implement the functionality described herein, such as a computer server, a desktop computing device, a laptop computing device, a smartphone, a computing tablet, or the like. The quantum computing system 12 includes the processor device(s) 14, the memory 16, and a system bus 70. The system bus 70 provides an interface for system components including, but not limited to, the memory 16 and the processor device(s) 14. The processor device(s) 14 can be any commercially available or proprietary processor.

The system bus 70 may be any of several types of bus structures that may further interconnect to a memory bus (with or without a memory controller), a peripheral bus, and/or a local bus using any of a variety of commercially available bus architectures. The memory 16 may include non-volatile memory 72 (e.g., read-only memory (ROM), erasable programmable read-only memory (EPROM), electrically erasable programmable read-only memory (EEPROM), etc.), and volatile memory 74 (e.g., random-access memory (RAM)). A basic input/output system (BIOS) 76 may be stored in the non-volatile memory 72 and can include the basic routines that help to transfer information between elements within the quantum computing system 12. The volatile memory 74 may also include a high-speed RAM, such as static RAM, for caching data.

The quantum computing system 12 may further include or be coupled to a non-transitory computer-readable storage medium such as the storage device 78, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 78 and other drives associated with computer-readable media and computer-usable media may provide non-volatile storage of data, data structures, computer-executable instructions, and the like.

A number of modules can be stored in the storage device 78 and in the volatile memory 74, including an operating system 75 and one or more program modules, such as the service event logging module 36, which may implement the functionality described herein in whole or in part. All or a portion of the examples may be implemented as a computer program product 79 stored on a transitory or non-transitory computer-usable or computer-readable storage medium, such as the storage device 78, which includes complex programming instructions, such as complex computer-readable program code, to cause the processor device(s) 14 to carry out the steps described herein. Thus, the computer-readable program code can comprise software instructions for implementing the functionality of the examples described herein when executed on the processor device(s) 14. The processor device(s) 14, in conjunction with the service event logging module 36 in the volatile memory 74, may serve as a controller, or control system, for the quantum computing system 12 that is to implement the functionality described herein.

Because the service event logging module 36 is a component of the quantum computing system 12, functionality implemented by the service event logging module 36 may be attributed to the quantum computing system 12 generally. Moreover, in examples where the service event logging module 36 comprises software instructions that program the processor device(s) 14 to carry out functionality discussed herein, functionality implemented by the service event logging module 36 may be attributed herein to the processor device(s) 14.

An operator, such as a user, may also be able to enter one or more configuration commands through a keyboard (not illustrated), a pointing device such as a mouse (not illustrated), or a touch-sensitive surface such as a display device. Such input devices may be connected to the processor device(s) 14 through an input device interface 80 that is coupled to the system bus 70 but can be connected by other interfaces such as a parallel port, an Institute of Electrical and Electronic Engineers (IEEE) 1394 serial port, a Universal Serial Bus (USB) port, an IR interface, and the like. The quantum computing system 12 may also include a communications interface 82 suitable for communicating with a network as appropriate or desired. The quantum computing system 12 may also include a video port configured to interface with the display device, to provide information to the user.

Individuals will recognize improvements and modifications to the preferred examples of the disclosure. All such improvements and modifications are considered within the scope of the concepts disclosed herein and the claims that follow.

What is claimed is:

1. A method, comprising:
obtaining, by a quantum computing system, event logging information from a plurality of event logging sources associated with execution of a quantum application, wherein the plurality of event logging sources comprises a quantum service and a classical service, and wherein the event logging information is descriptive of a plurality of service events and a corresponding plurality of timestamps;
detecting, by the quantum computing system, occurrence of an error at a particular time during the execution of the quantum application;
identifying, by the quantum computing system, a subset of service events from the plurality of service events and a corresponding subset of timestamps of the plurality of timestamps, wherein the subset of timestamps precedes the particular time; and
performing, by the quantum computing system, a corrective action for the error based at least in part on the subset of service events.

2. The method of claim 1, wherein performing the corrective action comprises:
identifying, by the quantum computing system, a subset of event logging sources of the plurality of event logging sources, each of the subset of event logging sources being associated with one or more of the subset of service events.

3. The method of claim 2, wherein identifying the subset of event logging sources of the plurality of event logging sources comprises:
causing, by the quantum computing system, simulation of the execution of the quantum application to obtain simulation information descriptive of an execution environment in which the quantum application was executed during a period of time preceding the particular time.

4. The method of claim 3, wherein identifying the subset of event logging sources of the plurality of event logging sources further comprises:
based on the simulation information, identifying, by the quantum computing system, a first quantum service of the subset of event logging sources as being causative of the error.

5. The method of claim 4, wherein causing the simulation of the execution of the quantum application to obtain the simulation information comprises:
providing, by the quantum computing system, the event logging information to a simulation system to simulate the execution of the quantum application, wherein the simulation system comprises a quantum computing device to simulate the quantum service and a classical computing device to simulate the classical service; and
responsive to providing the event logging information, receiving, by the quantum computing system, the simulation information from the simulation system.

6. The method of claim 4, wherein causing the simulation of the execution of the quantum application to obtain the simulation information comprises:
based on the event logging information, simulating, by the quantum computing system, the execution of the quantum application to obtain the simulation information.

7. The method of claim 6, wherein the subset of service events comprises a quantum service event associated with the quantum service; and
wherein simulating the execution of the quantum application comprises:
performing, by the quantum computing system, the quantum service event using a quantum computing device.

8. The method of claim 4, wherein performing the corrective action based at least in part on the subset of service events further comprises:
providing, by the quantum computing system to the first quantum service, information indicative of the error.

9. The method of claim 3, wherein causing the simulation of the execution of the quantum application to the obtain simulation information comprises:
causing, by the quantum computing system, simulation of execution of the quantum application with a first set of simulation parameters to obtain a first portion of the simulation information, wherein the first portion of the simulation information is descriptive of the execution environment in which the quantum application was executed during the period of time preceding the particular time; and
causing, by the quantum computing system, simulation of execution of the quantum application with a second set of simulation parameters different than the first set of simulation parameters to obtain a second portion of the simulation information, wherein the second portion of the simulation information is descriptive of an execution environment different than the execution environment in which the quantum application was executed during the period of time preceding the particular time.

10. The method of claim 1, wherein identifying the subset of service events and the corresponding subset of timestamps comprises:
determining, by the quantum computing system, the subset of timestamps of the plurality of timestamps, wherein the subset of timestamps comprises a sequence of timestamps immediately preceding the particular time; and
identifying, by the quantum computing system, the subset of service events, wherein the subset of service events comprises a sequence of service events that corresponds to the sequence of timestamps.

11. The method of claim 1, wherein identifying the subset of service events and the corresponding subset of timestamps comprises:
processing, by the quantum computing system, the event logging information with a machine-learned error sourcing model to obtain a model output that identifies the subset of service events of the plurality of service events, wherein the machine-learned error sourcing model is trained to predict which service events are causative of errors.

12. The method of claim 1, wherein the plurality of event logging sources comprises a plurality of quantum services, comprising:
a first quantum service implemented with a first set of qubits located at a first geographic location; and
a second quantum service implemented using a second set of qubits located at a second geographic location different than the first geographic location.

13. The method of claim 12, wherein obtaining the event logging information comprises:
receiving, by the quantum computing system at a first time, a first portion of the event logging information from a first computing system associated with the first set of qubits;
receiving, by the quantum computing system at a second time subsequent to the first time, a second portion of the event logging information from a second computing system associated with the second set of qubits; and
generating, by the quantum computing system, the event logging information based on the first portion of the event logging information and the second portion of the event logging information.

14. A quantum computing system comprising:
one or more computing devices to:
obtain event logging information from a plurality of event logging sources associated with execution of a quantum application, wherein the plurality of event logging sources comprises a quantum service and a classical service, and wherein the event logging information is descriptive of a plurality of service events and a corresponding plurality of timestamps;
detect occurrence of an error at a particular time during the execution of the quantum application;
identify a subset of service events of the plurality of service events and a corresponding subset of timestamps of the plurality of timestamps, wherein the subset of timestamps precedes the particular time; and
perform a corrective action for the error based at least in part on the subset of service events.

15. The quantum computing system of claim 14, wherein, to perform the corrective action, the one or more computing devices are to:
identify a subset of event logging sources from the plurality of event logging sources, each of the subset of event logging sources being associated with one or more of the subset of service events.

16. The quantum computing system of claim 15, wherein, to identify the subset of event logging sources from the plurality of event logging sources, the one or more computing devices are to:
cause simulation of the execution of the quantum application to obtain simulation information descriptive of an execution environment in which the quantum application was executed during a period of time preceding the particular time.

17. The quantum computing system of claim 16, wherein, to identify the subset of event logging sources from the plurality of event logging sources, the one or more computing devices are further to:
based on the simulation information, identify a first quantum service of the subset of event logging sources as being causative of the error.

18. The quantum computing system of claim 17, wherein, to cause the simulation of the execution of the quantum application to obtain the simulation information, the one or more computing devices are to:
provide the event logging information to a simulation system to simulate the execution of the quantum application, wherein the simulation system comprises a quantum computing device to simulate the quantum service and a classical computing device to simulate the classical service; and
responsive to providing the event logging information, receive the simulation information from the simulation system.

19. The quantum computing system of claim 17, wherein to cause the simulation of the execution of the quantum application to obtain the simulation information, the one or more computing devices are to:
based on the event logging information, simulate the execution of the quantum application to obtain the simulation information.

20. A non-transitory computer-readable storage medium that includes executable instructions to cause one or more processor devices of a quantum computing system to:
obtain event logging information from a plurality of event logging sources associated with execution of a quantum application, wherein the plurality of event logging sources comprises a quantum service and a classical service, and wherein the event logging information is descriptive of a plurality of service events and a corresponding plurality of timestamps;
detect occurrence of an error at a particular time during the execution of the quantum application; and
simulate one or more service events of the plurality of service events to obtain simulation information, wherein the one or more service events are respectively associated with one or more timestamps of the plurality of timestamps that occurred prior to the particular time, and wherein the simulation information is indicative of a causative service event of the one or more service events that is causative of the error.
